(19) United States
(12) Patent Application Publication
(10) Pub. No.: US 2015/0106575 A1
(43) Pub. Date: Apr. 16, 2015

(54) DATA WRITING DEVICE AND METHOD

(71) Applicant: FUJITSU LIMITED, Kawasaki-shi (JP)

(72) Inventor: Keita MATSUMOTO, Kawasaki (JP)

(73) Assignee: FUJITSU LIMITED, Kawasaki-shi (JP)

(21) Appl. No.: 14/489,619

(22) Filed: Sep. 18, 2014

(30) Foreign Application Priority Data
Oct. 11, 2013 (JP) 2013-213877

(51) Int. Cl. G06F 3/06

(52) U.S. Cl. CPC G06F 3/0659; G06F 3/0604; G06F 3/0673
USPC 711/154

(57) ABSTRACT

A data writing device includes a processor that executes a procedure. The procedure includes: performing first writing that writes data to a storage region of the storage section; and performing second writing that writes command execution data representing an execution state of each command of a program including a plurality of commands to an expected storage region, among the plurality of storage regions of the storage section, where it is expected that the first writing has not been performed.

### CROSS-REFERENCE TO RELATED APPLICATION

This application is based upon and claims the benefit of priority of the prior Japanese Patent Application No. 2013-213877, filed on Oct. 11, 2013, the entire contents of which are incorporated herein by reference.

### FIELD

The embodiments discussed herein are related to a data writing device, a storage medium stored with a data writing program, and a data writing method.

### BACKGROUND

Hitherto, when each command is executed of a program containing plural commands, data generated by such execution (command execution data) is stored in an investigation material storage region of fixed size at a predetermined position of a memory. This is performed such that, in the event of system runaway (panic) or the like, the command execution data stored in the investigation material storage region can be stored in a secondary storage device (crash dumping), to enable the cause of the runaway to be determined later.

### Related Patent Documents

Japanese Laid-Open Publication No. 2001-290678

Japanese Laid-Open Publication No. 2006-72931

### SUMMARY

An object of an aspect of technology disclosed herein is to enable saving of a greater amount of command execution data.

According to an aspect of the embodiments, a data writing device includes:

a processor;

a storage section including plural storage regions that store written data; and

a memory storing instructions, which when executed by the processor perform a procedure, the procedure including:

performing first writing that writes data to a storage region of the storage section; and

performing second writing that writes command execution data representing an execution state of each command of a program including a plurality of commands to an expected storage region, among the plurality of storage regions of the storage section, where it is expected that the first writing has not been performed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a business program execution device;

FIG. 2A is a diagram illustrating programs stored in ROM;

FIG. 2B is a diagram illustrating an OS, and a storage region for trouble investigation material, stored on a secondary storage device;

FIG. 3 is a diagram illustrating specific content of a virtual memory region;

FIG. 4 is a diagram illustrating a start-end page structure entity correspondence table;

FIG. 5 is a diagram illustrating relations between page structure entities, management structure entities, and empty regions;

FIG. 6 is a diagram illustrating specific content of a page structure entity;

FIG. 7 is a diagram illustrating specific content of a management structure entity that manages virtual memory addresses;

FIG. 8 is a diagram that illustrates a business program storage region correspondence table;

FIG. 9A is a functional block diagram of an OS;

FIG. 9B is a diagram illustrating processes of an OS;

FIG. 9C is a functional block diagram of a business program;

FIG. 9D is a diagram illustrating processes of a business program;

FIG. 10 is a flowchart illustrating an example of free page acquisition processing;

FIG. 11 is a flowchart illustrating an example of free page addition processing;

FIG. 12 is a flowchart illustrating an example of initial setting processing;

FIG. 13 is a diagram illustrating a manner in which command execution data is stored in a storage region when executing a business program;

FIG. 14 is a flowchart illustrating an example of command processing;

FIG. 15 is a flowchart illustrating an example of idle thread processing;

FIG. 16 is a flowchart illustrating an example of logging set processing;

FIG. 17 is a flowchart illustrating an example of logging release processing;

FIG. 18 is a flowchart illustrating an example of logging processing;

FIG. 19A is a diagram illustrating an empty region;

FIG. 19B is a diagram illustrating a sequence in which an OS writes data to empty regions;

FIG. 19C is a diagram illustrating a writing sequence of command execution data evacuation by logging processing;

FIG. 19D is a diagram illustrating an OS overwriting data over command execution data;

FIG. 19E is a diagram illustrating a sequence when overwriting data over command execution data;

FIG. 19F is a diagram illustrating a sequence of writing when evacuating command execution data by logging processing;

FIG. 20 is a flowchart illustrating an example of address thread stop processing;

FIG. 21 is a flowchart illustrating an example of address thread start processing;

FIG. 22A is a diagram illustrating overwriting a thread; and

FIG. 22B is a diagram illustrating evacuating a thread.

### DESCRIPTION OF EMBODIMENTS

Detailed explanation follows regarding an exemplary embodiment of technology disclosed herein, with reference to the drawings.

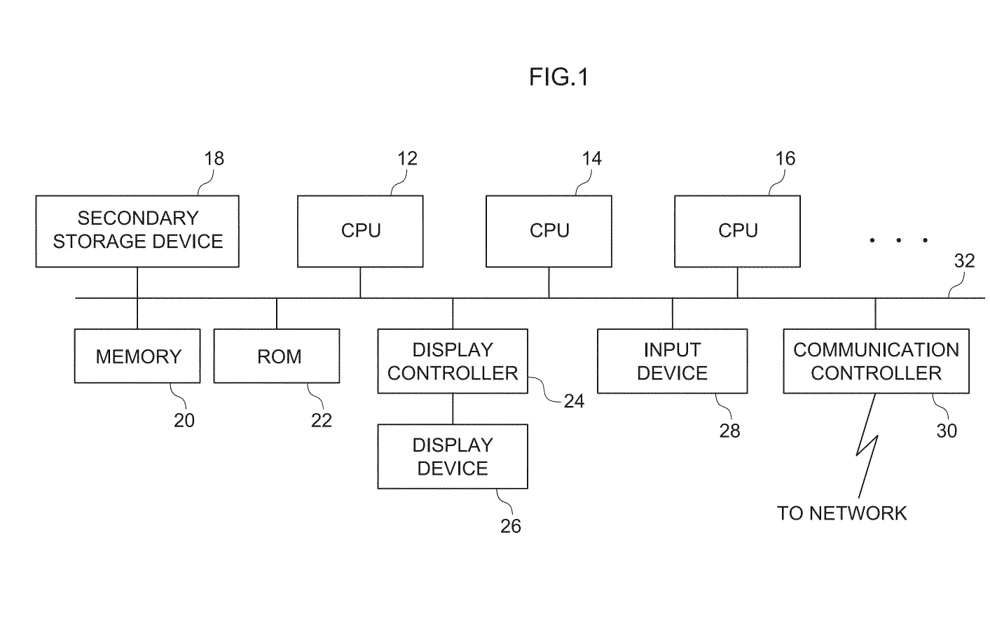

FIG. 1 illustrates a block diagram of a business program execution device. As illustrated in FIG. 1, the business program execution device includes plural Central Processing Units (CPU) 12, 14, 16, and so on. The business program execution device includes a secondary storage device 18, memory 20, Read Only Memory (ROM) 22, a display controller 24, a display device 26 connected to the display controller 24, an input device 28, and a communication controller 30. A liquid crystal display (LCD), a cathode ray tube (CRT), an organic electroluminescence display device (OELD), a plasma display panel (PDP), a field effect display (FED), or the like may be applied as the display device 26. A keyboard, or mouse may be applied as the input device 28. The plural CPU 12, 14, 16, and so on, the secondary storage device 18, the memory 20, the ROM 22, the display controller 24, the input device 28, and the communication controller 30 are connected together through a bus 32.

The business program execution device is an example of a “data writing device” of technology disclosed herein.

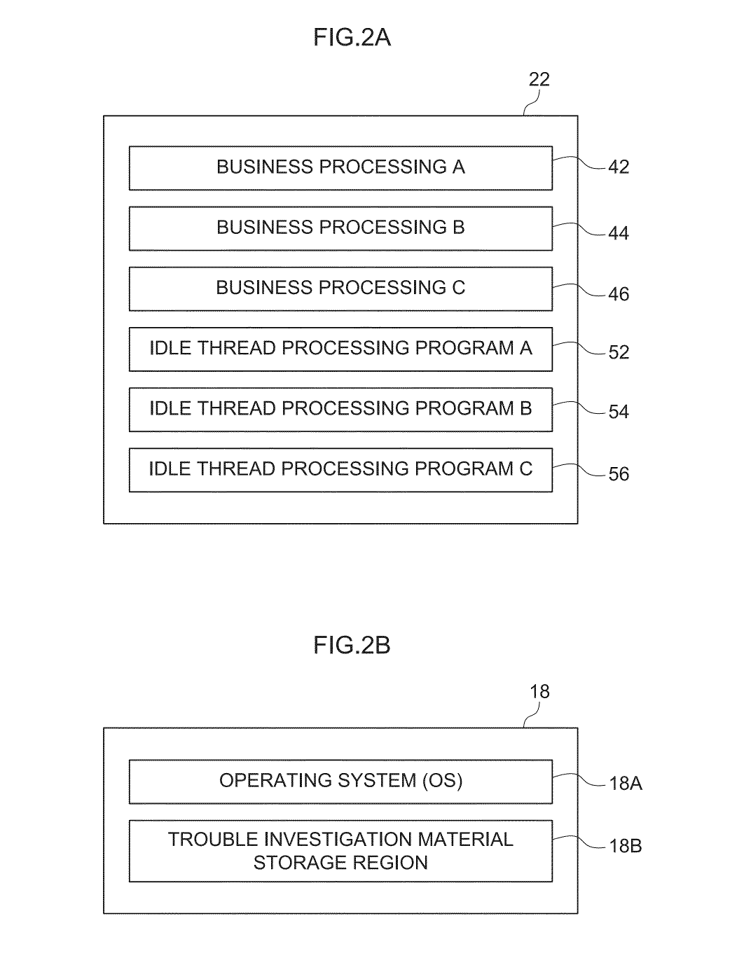

FIG. 2A illustrates a program stored in the ROM 22. As illustrated in FIG. 2A, plural business programs are stored in the ROM 22, such as a business program A42, a business program B44, and a business program C46. The ROM 22 is also stored with an idle thread processing program A52, an idle thread processing program B54, and an idle thread processing program C56, corresponding to the business program A42, the idle thread processing program B54, and the idle thread processing program C56, respectively.

As illustrated in FIG. 2B, an operating system (OS) 18A is stored in the secondary storage device 18. A storage region 18B that saves trouble investigation material (crash dumps) is also provided in the secondary storage device 18.

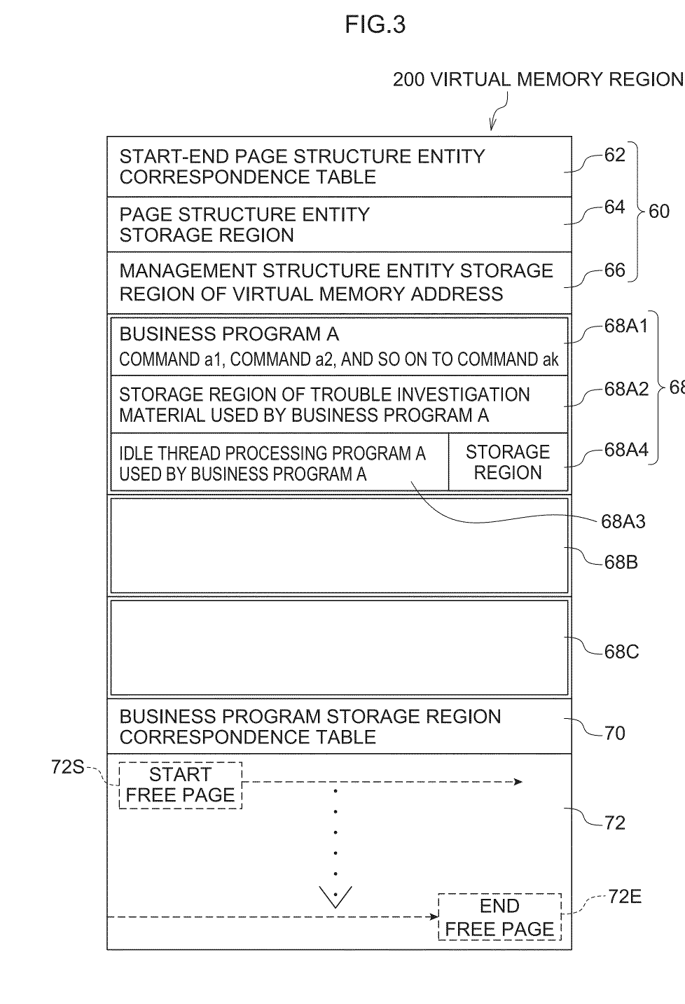

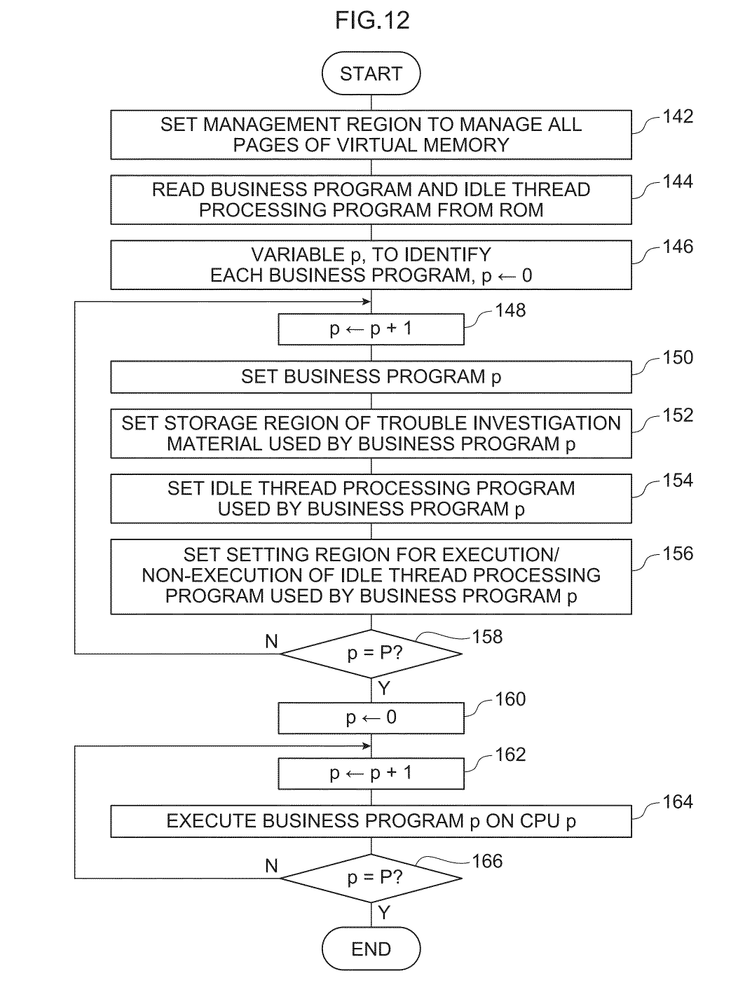

Specific content of a virtual memory region 200 is illustrated in FIG. 3. The storage region of the memory 20 is managed as the virtual memory region 200. A result of initial setting processing (FIG. 12), described later, a management region 60, a region 68A for use by the business program A42, a region 68B for use by the business program B44, a region 68C for use by the business program C46, and a business program storage region correspondence table 70 are set in the virtual memory region 200. An empty region 72 is a region in the virtual memory region 200 other than these regions (60, 68A, 68B, 68C, 70). A start-end page structure entity correspondence table 62, a page structure entity storage region 64, and a management structure entity storage region 66 are set in the management region 60. The contents set in each of the region 68A for use by the business program A42, the region 68B for use by the business program B44, and the region 68C for use by the business program C46 are the similar to each other. Explanation accordingly follows only for the set content of the region 68A for use by the business program A42. The region 68A for use by the business program A42 is set with a region 68A1 for storing the business program A42 including command a1, command a2, and so on to command ak, and a region 68A2 that stores trouble investigation material used by the business program A42. The region 68A for use by the business program A42 is set with a storage region 68A3 for storing the idle thread processing program A52 for use by the business program A42, and a setting region 68A4.

The memory 20 is an example of a “storage section” of technology disclosed herein.

The data designated for storing in a selected region of the virtual memory region 200 is stored by the OS 18A in the storage region of the memory 20 corresponding to the selected region of the virtual memory region 200.

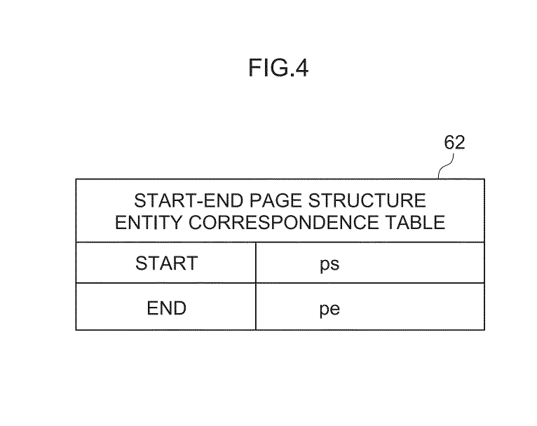

FIG. 4 illustrates the start-end page structure entity correspondence table 62. A pointer (address data) ps indicating a page stored with a start page structure entity, and a pointer (address data) pe indicating a page stored with an end page structure entity, corresponding to a start and an end, are stored in the start-end page structure entity correspondence table 62.

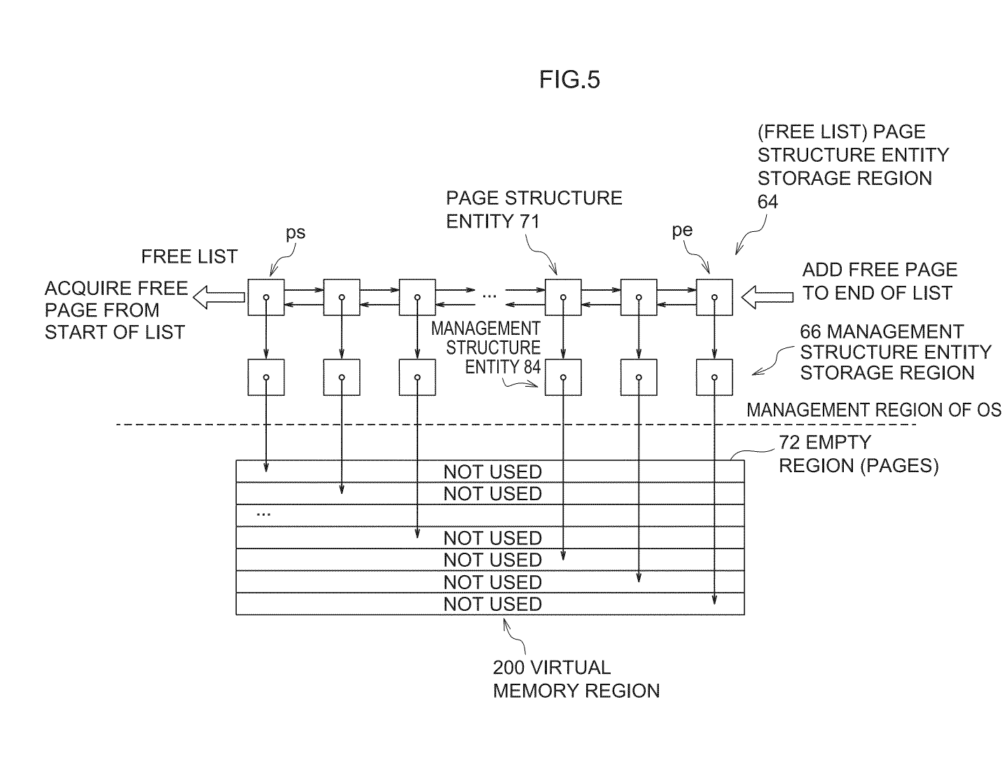

FIG. 5 illustrates a relationship between a page structure entity 71, a management structure entity 84, and the empty region 72. As illustrated in FIG. 5, the empty region 72 is divided into plural fixed size regions (free pages) that are not in use (not stored with data). Each of the free pages is stored in the management structure entity storage region 66, and managed by a structure entity (management structure entity) 84 that manages the virtual memory addresses of each of the free pages. The management structure entity 84 also manages the page structure entity 71 stored in the page structure entity storage region (free list) 64.

The free pages are examples of “storage regions” of technology disclosed herein.

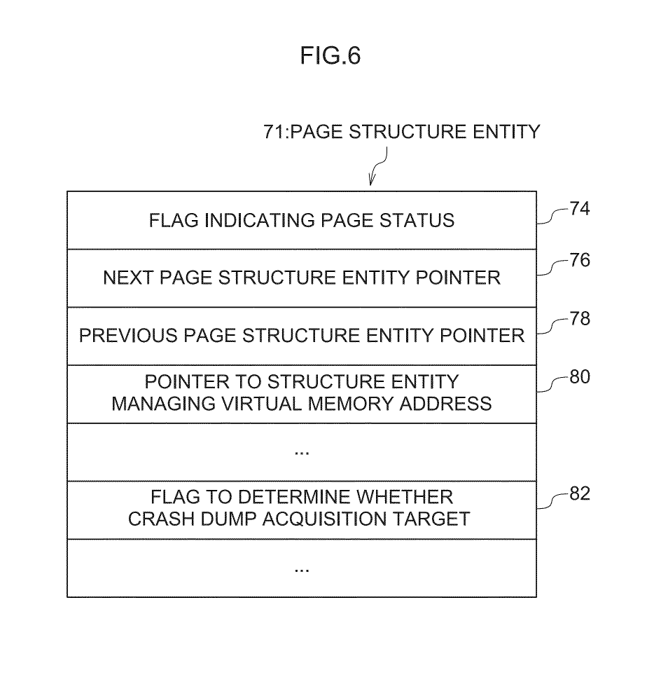

Specific content of the page structure entity 71 is illustrated in FIG. 6. The page structure entity 71 is a table stored with the following data. Namely, the page structure entity 71 is stored with a flag 74 indicating the status of a page (free page), a pointer 76 to the next page structure entity, and a pointer to the previous page structure entity. A pointer 80 to the structure entity (management structure entity) that manages the virtual memory address of the free page corresponding to the page structure entity 71, and a flag 82 for determining whether or not the corresponding page is an extraction target for a crash dump, are also stored in the page structure entity 71.

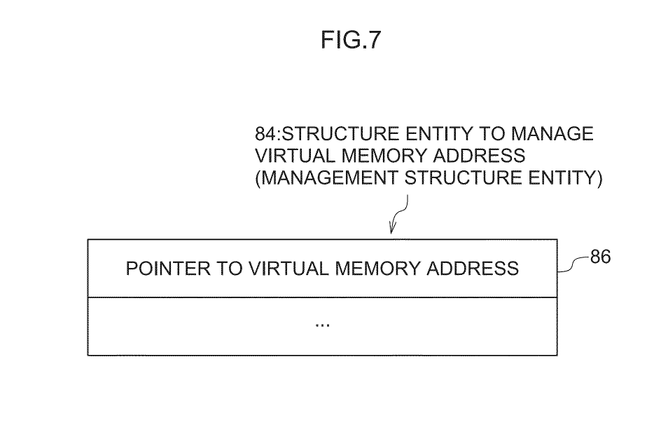

FIG. 7 illustrates specific content of the structure entity (management structure entity) 84 that manages virtual memory addresses. As illustrated in FIG. 7, the management structure entity 84 that manages virtual memory addresses is a table stored with pointers 86 to virtual memory addresses.

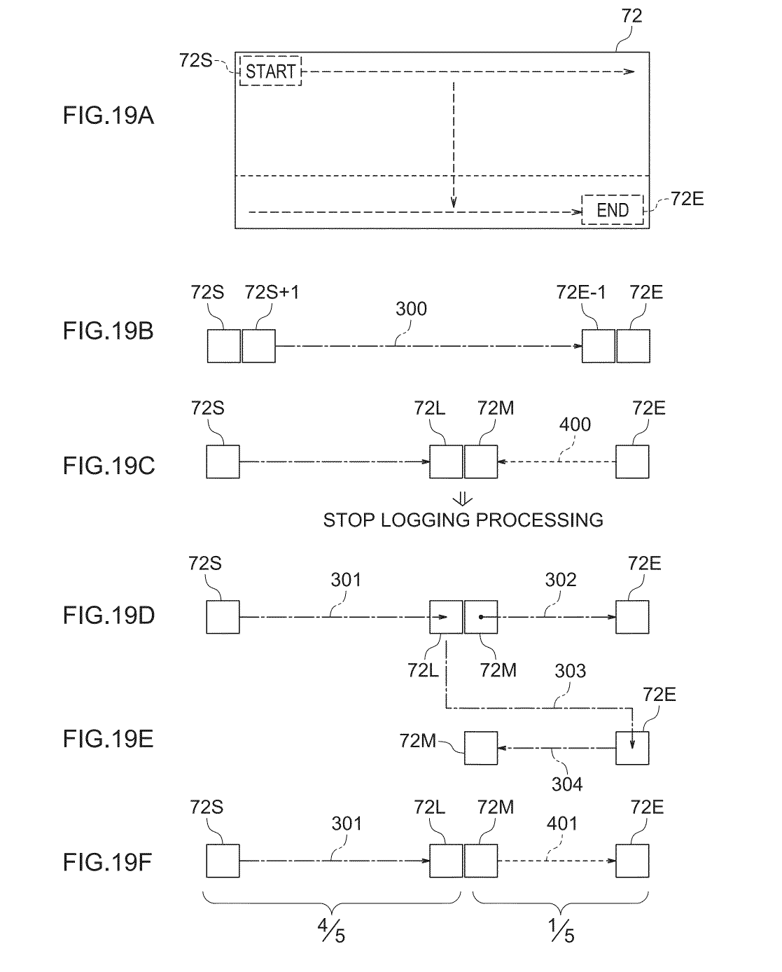

The OS 18A determines the sequence of data writing to the plural free pages of the empty region 72. For example, as illustrated in FIG. 3 and FIG. 19A, the OS 18A employs the left-top free page of the empty region 72 as the start free page 72S, and employs the right-bottom free page of the empty region 72 as the end free page 72E. The OS 18A determines the data writing sequence from the start free page 72S in sequence to the end free page 72E. As illustrated in FIG. 19B, a free page 72S+1 is the next page for data writing after the start free page 72S. A free page 72E−1 is the page for data writing prior to the end free page 72E.

As illustrated in FIG. 6, the page structure entity 71 is stored with the pointer 76 to the page structure entity 71 corresponding to a page designated for the OS 18A to write data to next after the page corresponding to the page structure entity 71. The page structure entity 71 is also stored with a pointer 78 to the page structure entity 71 corresponding to a page designated for the OS 18A to write data to prior to the page corresponding to the page structure entity 71.

For example, as illustrated in FIG. 19B, subsequent to the start free page 72S, data is written to the adjacent free page 72S+1 at the right side of the start free page 72S. Thus the pointer to the page structure entity 71 corresponding to the free page 72S+1 is stored in the page structure entity 71 of the start free page 72S as the entity pointer 76 (FIG. 6) to the next page structure.

As illustrated in FIG. 19B, the data one prior to the end free page 72E is written to the adjacent free page 72E−1 at the left side of the end free page 72E. Thus a pointer to the page structure entity 71 corresponding to the free page 72E−1 is stored in the page structure entity 71 of the end free page 72E as the entity pointer 78 (FIG. 6) to the previous page structure.

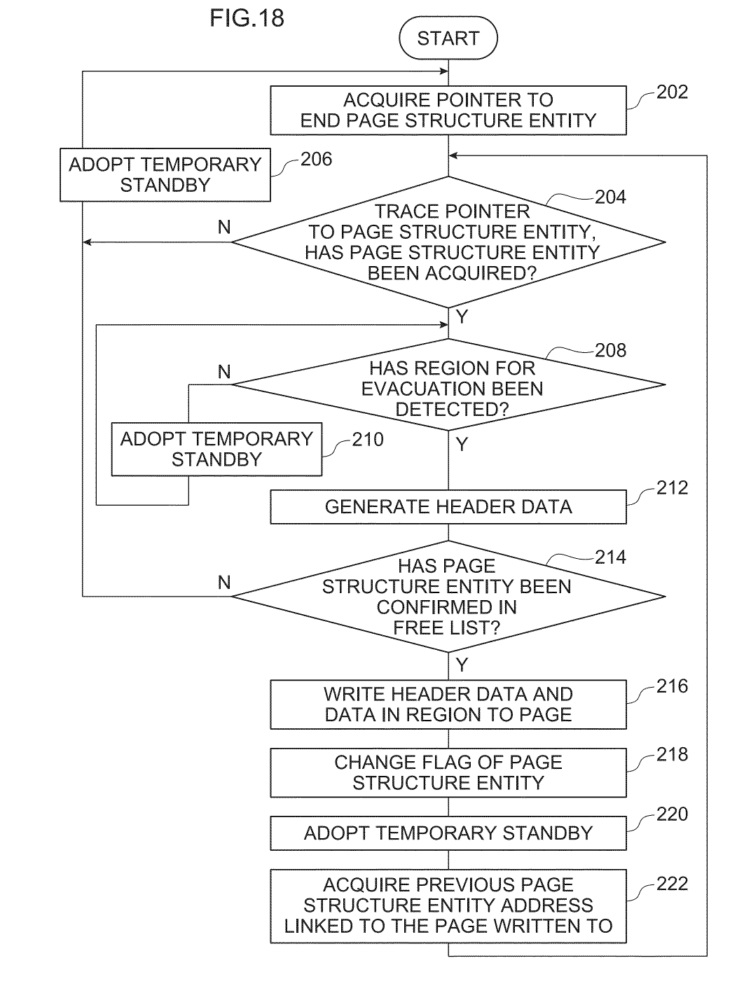

The page structure entity 71 is stored with the pointer 80 to the management structure entity 84. The page structure entity 71 is stored with a flag 82 to determine whether or not data stored in the corresponding page is the target of storage (dumping) to the storage region 18B (FIG. 2B) of the secondary storage device 18 during crash dumping. When panic occurs in the business program execution device, the OS 18A dumps the content stored in the trouble investigation material region 68A2 to the secondary storage device 18. The OS 18A determines whether or not to perform dumping extraction by referencing the flags 82 in the page structure entities 71 that manage each page. Hitherto none of the pages have been employed by the OS 18A for saving trouble investigation material. The flag 82 therefore indicates the dumping extraction necessity status. In the logging processing, described below, when the trouble investigation material has been evacuated, a page is set to be employed in dumping extraction by changing the flag 82 to “dump extraction required” (step 218 of FIG. 18).

When the OS 18A writes data to the start free page, the OS 18A acquires the pointer ps to the page structure entity 71 stored corresponding to the start from the start-end page structure entity correspondence table 62 (FIG. 4). The OS 18A ascertains the page structure entity 71 corresponding to the start free page based on the acquired pointer ps. The OS 18A ascertains the management structure entity 84 based on the pointer 80 in the ascertained page structure entity 71. The OS 18A ascertains the virtual memory address of the start free page from the pointers 86 in the ascertained management structure entity 84. The OS 18A writes data to the start free page at the ascertained virtual memory address.

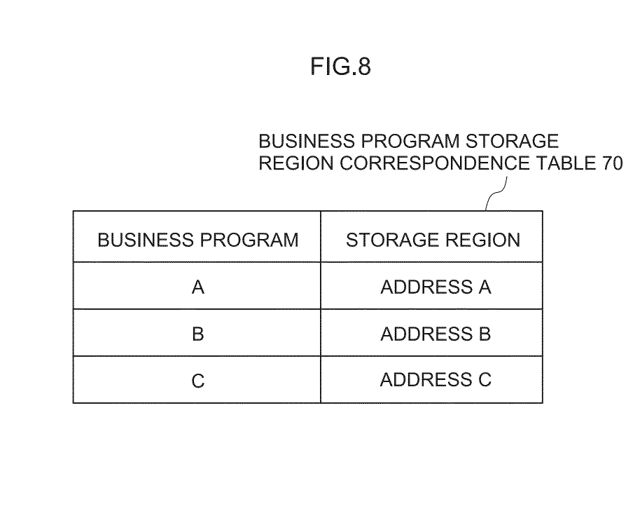

FIG. 8 illustrates a business program storage region correspondence table 70. As illustrated in FIG. 8, the business program storage region correspondence table 70 is a table stored with business programs and associated addresses of storage regions where the business programs are stored. The example in FIG. 8 is stored with address A associated with the business program A42, address B associated with the business program B44, and the address C associated with the business program C46.

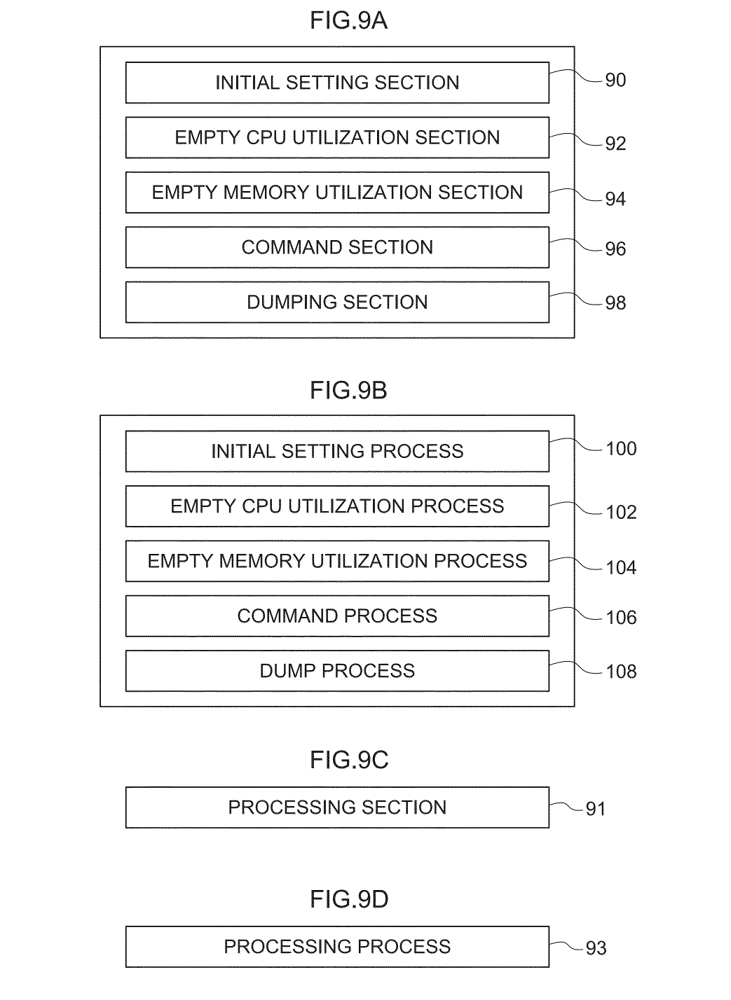

FIG. 9A is a functional block diagram of the OS 18A, and FIG. 9B illustrates processes of the OS 18A. As illustrated in FIG. 9A, functional components of the OS 18A include an initial setting section 90, an empty CPU utilization section 92, an empty memory utilization section 94, a command section 96, and a dumping section 98. As illustrated in FIG. 9B, the processes of the OS 18A include an initial setting process 100, an empty CPU utilization process 102, an empty memory utilization process 104, a command process 106, and a dumping process 108. For example, the CPU 12 operates as each of the functional components (90, 92, 94, 96, 98) of FIG. 9A by executing each of the processes (100, 102, 104, 106, 108).

FIG. 9C is a functional block diagram of a business program, and FIG. 9D illustrates processes of a business program. As illustrated in FIG. 9C, the functional components of the business program include a processing section 91. As illustrated in FIG. 9D, the processes of the business program include the processing process 93. For example, the CPU 14 operates as the processing section 91 of FIG. 9C by executing the processing process 93.

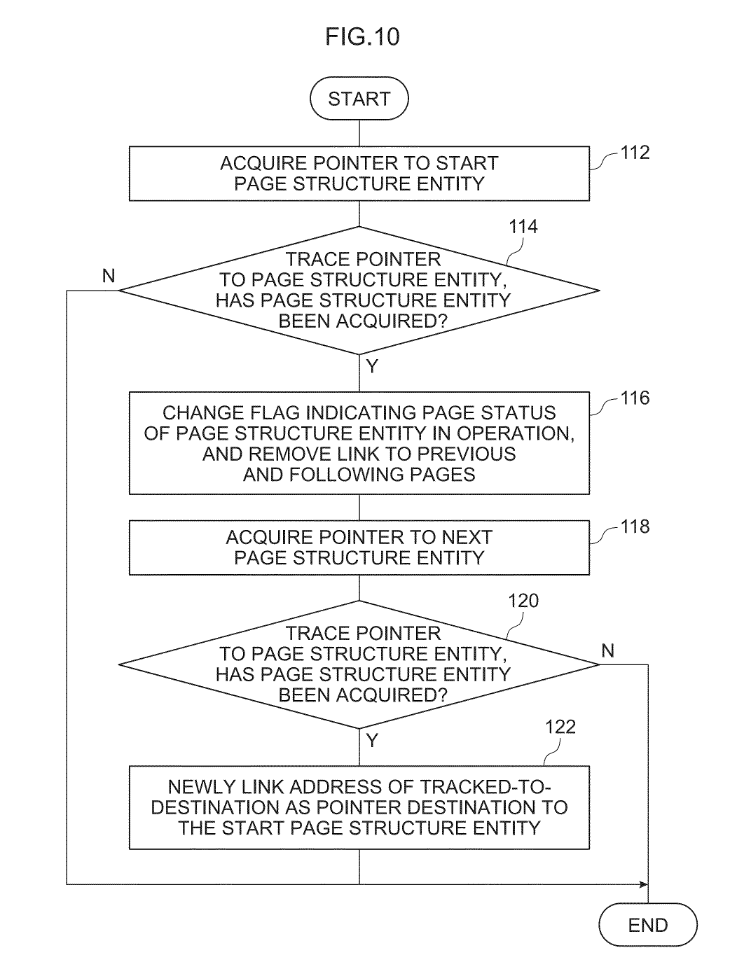

Explanation next follows regarding operation of the present exemplary embodiment. The OS 18A acquires a free page from the empty region 72 in the following circumstances. Namely, when a new business program is added to from the ROM 22 and written as a new business program to the empty region 72, and when data for executing each of the commands of a business program are written to the empty region 72. FIG. 10 is a flowchart illustrating an example of free page acquisition processing.

At step 112 of FIG. 10, the empty memory utilization section 94 acquires the pointer ps to the start page structure entity stored associated with the start from the start-end page structure entity correspondence table 62 (FIG. 4).

At step 114, the empty memory utilization section 94 freely selects one of the page structure entities 71 from the plural page structure entities 71 stored in the page structure entity storage region 64. For example, the empty memory utilization section 94 selects the page structure entity 71 at the center out of the plural page structure entities 71. The empty memory utilization section 94 tracks from the selected page structure entity 71 to the page structure entity 71 identified by the pointer ps based on the previous page structure entity pointer 78 (FIG. 6) in each of the page structure entities 71. In the example of FIG. 5, the empty memory utilization section 94 tracks across the page structure entities 71 toward the left side of the drawing. The empty memory utilization section 94 determines whether or not the page structure entity 71 identified by the pointer ps has been acquired by determining whether or not tracking has reached the page structure entity 71 identified by the pointer ps. If negative determination is made as the determination result of step 114, this means that there is no start free page, namely no free pages, and so free page acquisition processing is ended.

If affirmative determination is made as the determination result of step 114, then free page acquisition processing proceeds to step 116. At step 116, the empty memory utilization section 94 changes the flag 74 indicating the status of the page of the page structure entity 71 to in-use. This accordingly indicates that the page is not a free page. Moreover, the empty memory utilization section 94 removes the links to the previous and following pages. Namely, the empty memory utilization section 94 removes the next page structure entity pointer 76 from the page structure entity 71 of the start free page 72S (FIG. 19B), and removes the previous page structure entity pointer 78 from the next page structure entity. Thereby the start page is removed from under the management of the page structure entity storage region (free list) 64, and ceases to be the start page.

At step 118, the empty memory utilization section 94 acquires the pointer to the page structure entity 71 of the free page 72S+1 (FIG. 19B) designated for writing data to next after the start free page 72S (FIG. 19B). The OS 18A manages the page structure entity 71 of the free page 72S+1 in the page structure entity storage region 64, and so is able to acquire such a pointer.

At step 120, the empty memory utilization section 94 freely selects one of the page structure entities 71 of the plural page structure entities 71 stored in the page structure entity storage region 64. For example, the empty memory utilization section 94 selects the page structure entity 71 at the center out of the plural page structure entities 71. The empty memory utilization section 94 tracks from the selected page structure entity 71 to the page structure entity 71 of page 72S+1 based on the pointers 78 (FIG. 6) to the previous page structure entity in each of the page structure entities 71. In the example of FIG. 5, the empty memory utilization section 94 tracks across the page structure entities 71 toward the left side of the drawing. The empty memory utilization section 94 determines whether or not the next page structure entity identified by the pointer acquired at step 118 has been acquired by determining whether or not tracking has reached the page structure entity 71 of the free page 72S+1. If negative determination is made as the determination result of step 120, this means that there are no free pages, and so free page acquisition processing is ended.

If affirmative determination is made as the determination result of step 120 then the current free page acquisition processing proceeds to step 122. At step 122, the empty memory utilization section 94 newly links the address destination tracked to at step 120 as a pointer destination to the start page structure entity. Namely, the empty memory utilization section 94 stores the address of the pointer acquired at step 118 associated with the start in the start-end page structure entity correspondence table 62 (FIG. 4). The page that was the next page is accordingly managed as the start page.

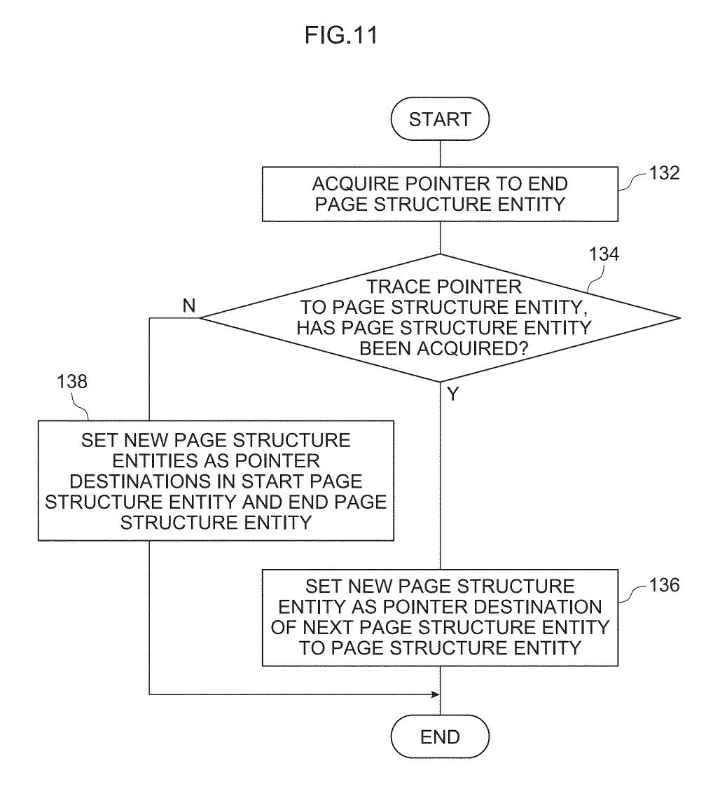

If a page ceases to be used due to the OS 18A ending execution of the business program, or transitioning to the next command, then this page is treated as a free page. FIG. 11 illustrates a flowchart of an example of free page adding processing to add a free page to the page structure entity storage region (free list) 64.

At step 132, the empty memory utilization section 94 acquires the pointer pe to the end page structure entity 71 stored in association with the end in the start-end page structure entity correspondence table 62 (FIG. 4).

At step 134, the empty memory utilization section 94 starts out from the pointer 76 to the next page in the page structure entity 71 freely selected from out of the plural page structure entities 71 stored in the page structure entity storage region 64. The empty memory utilization section 94 tracks as far as the end page structure entity 71 identified by the pointer pe. In the example of FIG. 5, the empty memory utilization section 94 tracks the page structure entities 71 towards the right side of the diagram. The empty memory utilization section 94 determines whether or not the structure entity 71 identified by the pointer pe has been acquired. If affirmative determination is made as the determination result of step 134, then the free page adding processing proceeds to step 136. If negative determination is made as the determination result of step 134, then the free page adding processing proceeds to step 138.

At step 136, the empty memory utilization section 94 sets the address of a new page structure entity as the pointer 76 of the next page structure entity in the page structure entity 71 of the end page. The empty memory utilization section 94 also sets a pointer to the page structure entity 71 of the end page as the previous page structure entity pointer 78 in the new page structure entity 71. Moreover, the empty memory utilization section 94 stores the address of the page structure entity of the new page associated with end in the start-end page structure entity correspondence table 62 (FIG. 4). The processing of step 136 sets the newly added pages as the end page and sets the previous end page as the page one previous to the end page.

If negative determination is made as the determination result of step 134, then this means there is no end page, namely there are no free pages. At step 138, the empty memory utilization section 94 sets the pointer destinations of the new page structure entity as the start page structure entity and the end page structure entity of the start-end page structure entity correspondence table 62 (FIG. 4).

The empty memory utilization section 94 is an example of a “first writing section” of technology disclosed herein.

FIG. 12 is a flowchart illustrating an example of initial setting processing in which the OS 18A sets the content of the virtual memory region 200 when power is introduced to the business program execution device. At step 142 of FIG. 12, the initial setting section 90 sets the management region 60 for managing all pages of the virtual memory. The start-end page structure entity correspondence table 62, the page structure entity storage region 64, and the management structure entity storage region 66 are set thereby.

At step 144, the initial setting section 90 reads the business program and the idle thread processing program from the ROM 22.

At step 146, the initial setting section 90 initializes variable p that identifies each of the business programs to 0. For example, the business program A42 is identified when variable p=1. At step 148, the initial setting section 90 increments the variable p by 1. At step 150, the initial setting section 90 sets the business program identified by the variable p (referred to below as “business program p”) in the virtual memory region 200. Then, at step 152, the initial setting section 90 sets the storage region 68A for the trouble investigation material to be employed by the business program p. Namely, if the business program A42 is identified by variable p=1, then the initial setting section 90 stores the business program A42 in the region 68A1, and sets the storage region 68A2 of the trouble investigation material to be employed by the business program A42. Note that the number of storage regions in the storage region 68A2 is fixed at a specific value.

At step 154, the initial setting section 90 sets (stores) the idle thread processing program to be employed by the business program p. Namely, if the business program A42 is identified by variable p=1, then the initial setting section 90 stores the idle thread processing program A52 in the storage region 68A3. At step 156, the initial setting section 90 sets the storage region 68A2 for the execution or non-execution for the idle thread processing program to be employed by the business program p.

At step 158, the initial setting section 90 determines whether or not the variable p is a total number P of the business programs. If negative determination is made as the determination result of step 158, then the initial setting processing returns to step 148, and the above processing (steps 148 to 158) is executed. If affirmative determination is made as the determination result of step 158, then the initial setting processing proceeds to step 160.

At step 160, the initial setting section 90 initializes the variable p to 0, and at step 162 the initial setting section 90 increments the variable p by 1. At step 164, the initial setting section 90 executes the business program p in a CPU p selected to employ the business program p from out of the plural CPUs 12, 14, 16, and so on.

At step 166, determination is made as to whether or not the variable p is the total number P. If negative determination is made as the determination result of step 166, then the initial setting processing proceeds to step 162. If affirmative determination is made as the determination result of step 166, then the initial setting processing is ended.

The above processing is executed by the business program A42, the business program B44, and the business program C46. However, the idle thread processing program A52 for use by the business program A42, the idle thread processing program B54 for use by the business program B44, and the idle thread processing program C56 for use by the business program C46 are not executed at this stage.

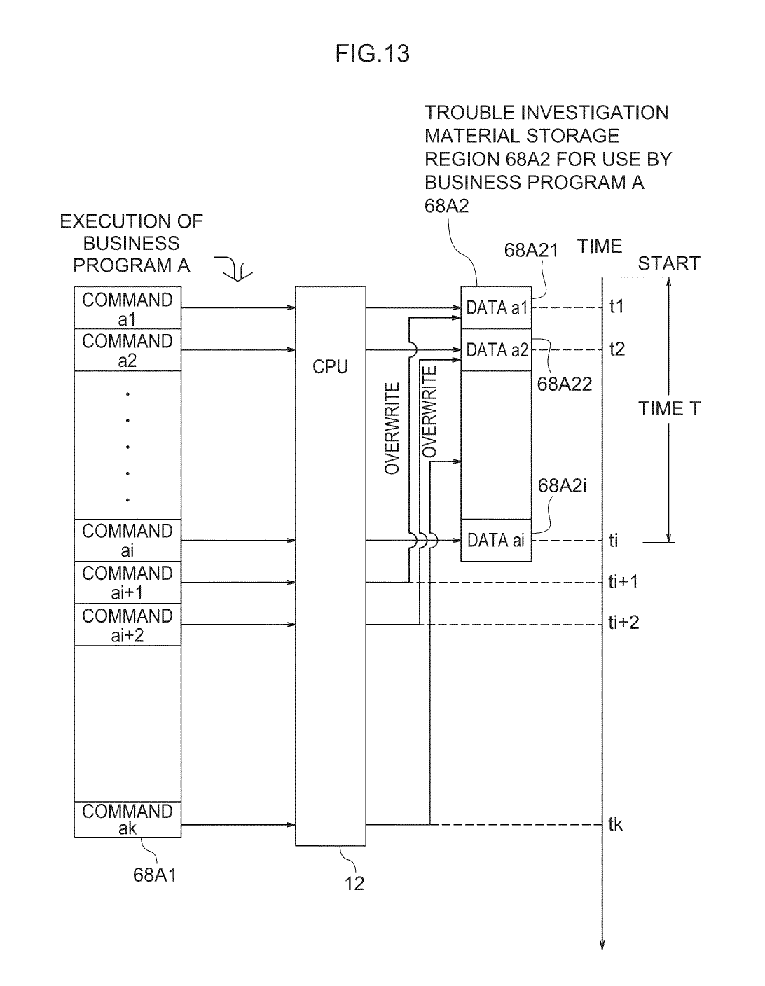

FIG. 13 illustrates a situation in which command execution data representing execution state of commands is stored in the storage region 68A2 when each of the commands a1, a2, and so on to ak of the business program A42 are executed, for example, at step 164 (FIG. 12). The storage processing of the command execution data is performed as a portion of a command.

The command execution data includes the following types of data. A first type is data generated when the command is executed. Which data is generated is determined by the content of the command of the business program. For example, if the content of the command is a designated computation then the computation result thereof is the command execution data. If the content of the command is to browse a determined web site then the number of bits of data received by such browsing is command execution data.

A second type is data employed to execute a command. For example, if the command employs an intermediate computation result of a command (computation processing) already executed, then the intermediate computation result of a command (computation processing) already executed is command execution data.

A third type is data that identifies an executed command (thread).

When execution of the business program A42 has started, the command section 96 of the OS 18A first executes the command a1 in the CPU 12. The CPU 12 executes the command a1. The command execution data a1 is generated by execution of the command a1. The generated command execution data a1 is stored in a storage region 68a21 at time t1.

Similarly, when the command a2 is executed, the command execution data a2 is stored at time t2 in a region 68A22 different to the region 68a21 where the command execution data a1 was stored in the storage region 68A2. When the command ai is executed, the command execution data ai is stored in a region 68A2i at time ti (time T from when the business program A42 was started).

When the next command ai+1 is executed, the command execution data ai+1 is stored at time ti+1 in the 68A21 where the command execution data a1 was stored. The command execution data ai+1 overwrites the command execution data a1 when the command execution data ai+1 is stored in the region where the command execution data a1 was stored. The command execution data a1 is accordingly erased. Thus the command execution data a1 would not be acquirable during a crash dump, and the execution status of the command a1 would not be ascertainable. Therefore in the present exemplary embodiment the following logging processing is executed.

The command section 96 is an example of a “third writing section” of technology disclosed herein.

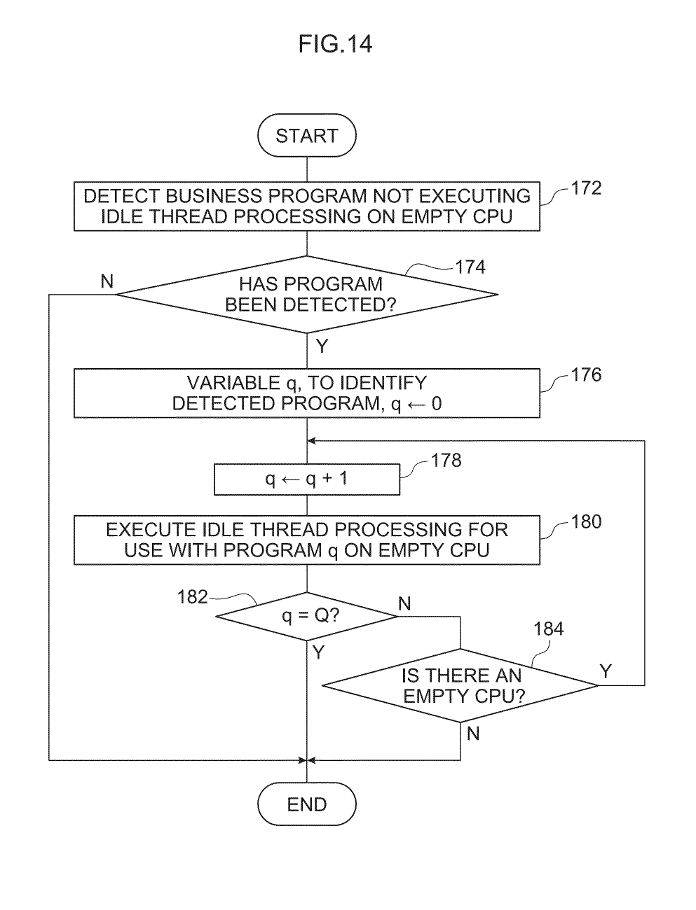

FIG. 14 illustrates a flowchart of an example of command processing the OS 18A executes for idle thread processing on an empty CPU when the OS 18A detects that an empty CPU has entered an idle state. At step 172 in FIG. 14, the empty CPU utilization section 92 detects a business program not executing an idle thread processing on an empty CPU.

At step 174, the empty CPU utilization section 92 determines whether or not such a business program has been detected. If negative determination is made as the determination result of step 174, then the command processing to execute the idle thread processing is ended. If affirmative determination is made as the determination result of step 174, then the present command processing proceeds to step 176.

At step 176, the empty CPU utilization section 92 initializes a variable q for identifying the detected idle thread processing program to 0, and at step 178, the empty CPU utilization section 92 increments the variable q to 1.

At step 180, the empty CPU utilization section 92 executes the idle thread processing program for use with the detected business program q on the empty CPU. For example, if the business program A42 is identified by q=1, then execution of the idle thread processing program A52 is allocated to the empty CPU.

At step 182, the empty CPU utilization section 92 determines whether or not the variable q is equal to a total number Q of the detected business programs. If negative determination is made as the determination result of step 182, then command processing execution of the idle thread processing proceeds to step 184. If affirmative determination is made as the determination result of step 182, then the present command processing is ended.

At step 184, the empty CPU utilization section 92 data determines whether or not there is another empty CPU. If negative determination is made as the determination result of step 184, then command processing execution of the idle thread processing is ended. If affirmative determination is made as the determination result of step 184 then the present command processing proceeds to step 178.

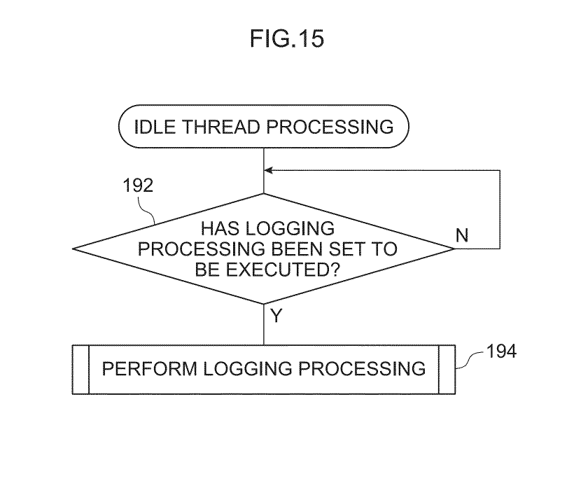

Explanation follows regarding idle thread processing. Idle thread processing is executed by an idle thread processing program corresponding to each business program. The idle thread processing program A52 to idle thread processing program C56, corresponding to the business program A42 to business program C46, are similar to each other, and so only the idle thread processing program A52 is explained below. FIG. 15 illustrates a flowchart of an example of idle thread processing. At step 192 of FIG. 15, the processing section 91 determines whether or not logging processing has been set to execute by a user. If negative determination is made as the determination result of step 192, then the present processing proceeds to step 192. Thus when logging processing has not been set to execute, the CPU continues to execute the determination processing (step 192).

If affirmative determination is made as the determination result of step 192, processing proceeds to step 194. At step 194, the processing section 91 executes logging processing.

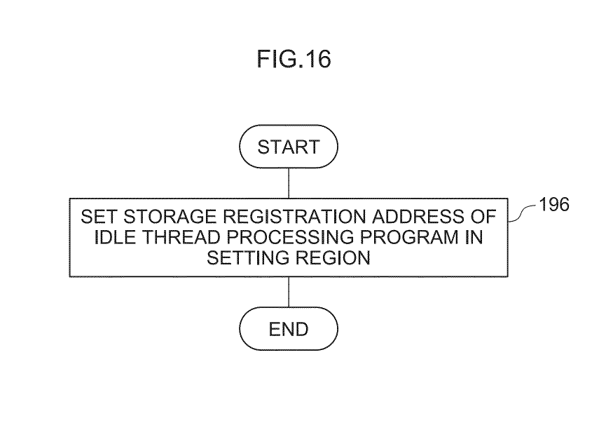

FIG. 16 is a flowchart illustrating an example of processing that sets (loads) logging processing of idle thread processing to be executed. A user, for example, uses the input device 28 to input (load) data of logging processing to be executed for the business program A42. When the command section 96 of the OS 18A detects loading, at step 196 of FIG. 16, the command section 96 sets a registration address for the idle thread processing program A52 in the setting region 68A4. Thus affirmative determination is made at the determination of step 192 of FIG. 15.

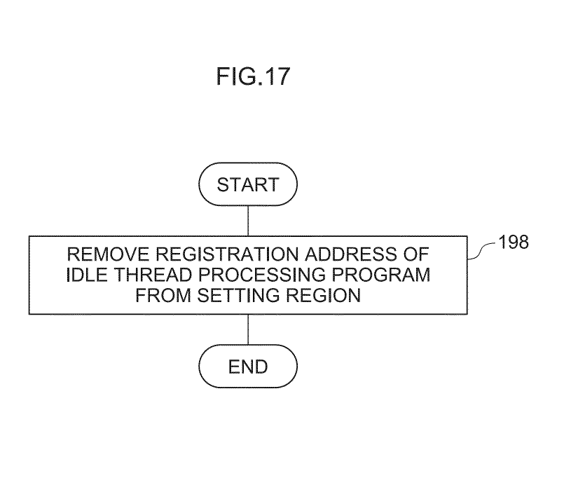

FIG. 17 is a flowchart illustrating an example of processing to release (unload) logging processing of the idle thread processing. A user, for example, uses the input device 28 to input (unload) data so as to stop execution for the business program A42. When the command section 96 of the OS 18A detects such unloading, at step 198 of FIG. 17, the command section 96 removes the registration address of the idle thread processing program A52 from the storage region A4. Negative determination is accordingly made at the determination of step 192 of FIG. 15.

This thereby enables a user to select a business program and execute logging processing, or select a business program and end logging processing.

The input device 28 is an example of a “writing setting section” and a “stopping setting section” of technology disclosed herein.

FIG. 18 is a flowchart illustrating an example of logging processing of step 194 of FIG. 15. At step 202 of FIG. 18, the processing section 91 acquires the pointer pe (FIG. 4) of the end page structure entity of the page structure entity storage region (free list) 64. At step 204, the processing section 91 freely selects one of the page structure entities 71 from out of the plural page structure entities 71 stored in the page structure entity storage region 64. For example, the processing section 91 selects the page structure entity 71 at the center out of the plural page structure entities 71. The processing section 91 tracks from the selected page structure entity 71 to the end page structure entity identified by the pointer pe (toward the right side in FIG. 5), based on the next page structure entity pointer 76 in each of the page structure entities 71 (FIG. 6). By determining whether or not tracking has reached the end page structure entity, the processing section 91 determines whether or not page structure entities of the number of pages of the storage region 63A2 (see FIG. 13), including the end page structure entity identified by the pointer pe, have been acquired. Determination as to whether page structure entities of the number of pages of the storage region 63A2 (see FIG. 13) have been acquired is performed in order for the processing section 91, at step 216, described below, to evacuate in one move the command execution data stored in all of the storage region 68A2 (see FIG. 13).

When negative determination is made as the determination result of step 204, the absence of usable free pages can be determined, and logging processing proceeds to step 206. At step 206, the processing section 91 is temporarily placed on standby. Sometimes free pages are added, as described above (FIG. 10), when temporarily placed on standby. In such cases, affirmative determination is made for the determination result of step 204. If affirmative determination is made as the determination result of step 204 then logging processing proceeds to step 208.

At step 208, the processing section 91 references the business program storage region correspondence table 70 (FIG. 8) and, for example, acquires the address A stored associated with the business program A42, and, based on the address A, determines whether or not the storage region 68A2 can be detected for evacuation.

The idle thread processing (logging processing) is executed independently of the corresponding business program. Therefore, even in a state set by a user to execute logging processing, as described above, sometimes there is no corresponding business program present in the memory 20. Note that when there is no corresponding business program present in the memory 20, the address stored in the storage region corresponding to the corresponding business program of the business program storage region correspondence table 70 is removed by the OS 18A. In such cases, negative determination is made at the determination result of step 208. Logging processing proceeds to step 210 if negative determination is made as the determination result of step 208. At step 210, the processing section 91 is placed temporarily on standby. When temporarily on standby, sometimes the corresponding business program is stored (restored) in the memory 20. In such cases, address of the storage region corresponding to the corresponding business program in the business program storage region correspondence table 70 is stored (restored) by the OS. Affirmative determination is accordingly made as the determination result of step 208. Logging processing proceeds to step 212 if affirmative determination is made as the determination result of step 208.

At step 212, the processing section 91 generates header data. Herein, header data includes a magic number, a sequence number, a time stamp, the used CPU number, a region attribute, and a check sum. The magic number indicates which business program the investigation material corresponds to. The sequence number indicates which command the investigation material corresponds to. The region attribute is data identifying the specific type of the content of the investigation material.

The header data is an example of “data that specifies a command” of technology disclosed herein.

At step 214, the processing section 91 confirms whether or not the page structure entity is in the page structure entity storage region (free list) 64. Even if determination was made at step 204 that the page structure entity had been acquired, if negative determination is made as the determination result of step 208, then the logging processing is temporarily placed on standby at step 210. When the logging processing is temporarily placed on standby, sometimes the OS 18A employs the page corresponding to the page structure entity at step 204. In such cases, the page structure entity at step 204 is removed from the page structure entity storage region (free list) 64 (FIG. 10). Negative determination is accordingly made as the determination result of step 214. The logging processing proceeds to step 206 is such cases. As described above, the logging processing is placed on standby at step 206. During the time when the logging processing is placed on standby, the pages are unlocked, and the page structure entities are added to the page structure entity storage region (free list) 64 (FIG. 11). Affirmative determination is accordingly made as the determination result of step 214 in such cases.

The logging processing proceeds to step 216 if affirmative determination is made as the determination result of step 214. At step 216, the processing section 91 writes the header data and the command execution data of the storage region 68A2 to the pages. Namely, the processing section 91 confirms the management structure entity 84 based on the pointers 80 to the management structure entities 84 in the page structure entities 71 acquired at step 204. Based on the pointers 86 of the confirmed management structure entities 84, the processing section 91 stores (evacuates) the header data and the command execution data in the pages corresponding to the page structure entities 71 acquired at step 204.

At step 218, the processing section 91 changes the flags 82 of the page structure entities 71 to crash dump extraction target. Namely, the processing section 91 changes the flag 82 to “dump extraction required”.

At step 220, the processing section 91 adopts standby time T as described above. Plural commands are executed by the processing of step 216 while time T elapses, as described above (FIG. 13), and the command execution data is newly stored in the storage region 68A2. From the time the logging processing transitions to step 220 until the above time T has elapsed, more new data risks being overwritten over the data newly stored in the storage region 68A2.

Therefore, the logging processing proceeds to step 22 in order to re-evacuate the command execution data stored in the storage region 68A2. At step 222, the processing section 91 acquires the previous page structure entity address linked to the page written to by the logging processing.

The following is the reason configuration is made to acquire the previous page structure entity address at step 222 as described above. Namely, this is so that the processing section 91 writes command execution data to the free pages in the reverse sequence (400 (FIG. 9C)) to the sequence (300 (FIG. 19B)) the OS 18A writes data to the free pages of the empty region 72 (FIG. 19A). This because a specific number of free pages including the end free page 72E are free pages not expected to have been written with data by the empty memory utilization section 94. The free pages not expected to be written with data by the empty memory utilization section 94 include, firstly, free pages not expected to have been written with any data, and secondly, free pages that are not expected to be written with data until after a specific period of time. The specific period of time is obtained based in previous statistical values, and is an expected period of time from when power was introduced to the business program execution device until a crash dump is expected to occur. Note that since the above specific period of time is obtained based on statistical values in this manner, sometimes the data has actually been written to the specific number of free pages expected not to be written with data by the empty memory utilization section 94.

Moreover, the number of “previous page structure entities” at step 222 is the number of pages of the storage region 68A2 (see FIG. 13). This is because the command execution data stored in the all the regions of the storage region 68A (see FIG. 13) is evacuated in a single move at the step 216 executed after the processing of step 222.

After step 222, logging processing proceeds to step 204, and the processing section 91 executes the above processing (steps 204 to 222). Note that at step 204 in the progression of the logging processing after the processing of step 222, the processing section 91 determines whether or not page entities of the number of pages of the region 68A2 (see FIG. 13) have been acquired based on the previous page structure entity address acquired at step 222.

As stated above (FIG. 13), plural commands are executed, and command execution data is stored in the storage region 68A2. When the time T has elapsed from the logging processing transitioning to step 220, new command execution data risks being overwritten over the command execution data stored in the storage region 68A2. Thus, at step 216, prior to overwriting the new command execution data, the logging processing evacuates the command execution data stored in all the regions of the storage region 68A2 to the free pages of the virtual memory region 200, as described above.

The processing section 91 is an example of the “second writing section” of technology disclosed herein.

As described above, in the logging processing, the flags 82 in the page structure entities 71 managing the pages of the empty region 72 that are the destination for the evacuated investigation material are changed to indicate their becoming crash dump extraction targets. When one of the CPUs runs out of control (when panic has occurred), the dumping section 98 determines whether or not the pages of the empty region 72 are memory dump extraction targets by examining the content of the respective flag 82. The dumping section 98 then stores (dumps) the investigation material in the storage region 18B of the secondary storage device 18 (see FIG. 2B).

Idle thread processing is, however, forcibly ended in the following situations, and continues to be executed in situations other than the following.

First, the idle thread processing is forcibly ended in cases in which the CPU executing the idle thread processing is employed to execute a business program.

Second, sometimes all of the free pages are used as illustrated in FIG. 19C. Namely, the logging processing is forcibly ended when, due to the OS 18A executing a business program or the like, data is written to the free pages 72S to 72L, and header data and command execution data has been written to the free pages 72E to 72M. Note that due to execution of the business program or the like, when data is written, the OS 18A uses the page 72M onwards (see the sequence 302 of FIG. 19D). In such cases, data is overwritten to the saved command execution data.

Third, the logging processing is forcibly ended when panic has occurred in a kernel of the OS 18A.

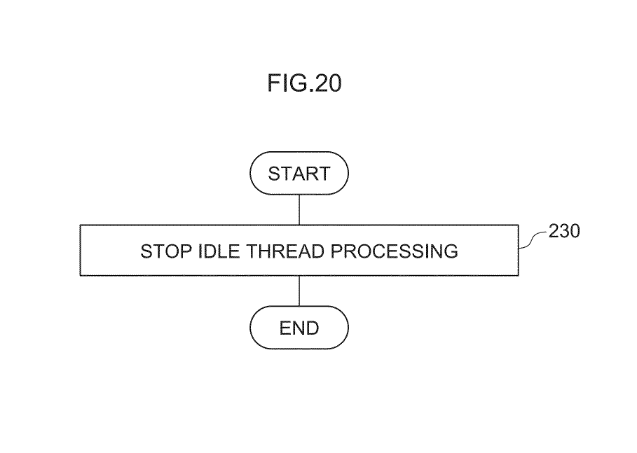

The following processing is started when the CPU executing the idle thread processing is used to execute a business program, when the OS 18A detects that all of the free pages have been used, or that panic has occurred in a kernel of the OS 18A. Namely, idle thread processing stop processing as illustrated in FIG. 20 is started, and at step 230 the command section 96 stops the idle thread processing.

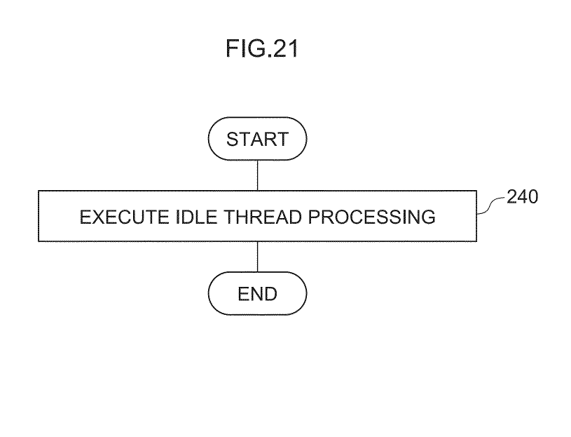

However, the following processing is started when, after the second case (FIG. 19B), the OS 18A has detected a case in which free pages have been added, or the panic in the kernel has been resolved. Namely, the idle thread processing execution processing illustrated in FIG. 21 is started, and at step 240 the command section 96 executes the idle thread processing.

Explanation next follows regarding advantageous effects of the present exemplary embodiment.

First Advantageous Effect

In the logging processing, command execution data (investigation material) is evacuated from the storage region 68A2 (FIG. 3, FIG. 13) to the empty region 72, thereby enabling more command execution data to be saved than the storable capacity of the storage region 68A2 (FIG. 3, FIG. 13). Moreover, in the logging processing, when evacuating the command execution data, the free pages are used in the reverse sequence to the sequence a business program or the like employs the free pages of the empty region 72. This enables the amount of saved content (command execution data) overwritten to be lessened in a state in which there is an empty region 72 present. The command execution data is first stored in the fixed region of the storage region 68A2 (FIG. 3, FIG. 13), and prior to overwriting the command execution data stored in the storage region 68A2, the command execution data is evacuated to the empty region 72. This thereby enables overwriting of command execution data to be lessened further.

Second Advantageous Effect

The OS 18A executes the logging processing on an empty CPU, thereby enabling impeding of the processing of the CPUs performing business processing to be prevented. When the OS then executes business processing on the CPU executing the logging processing, the logging processing is stopped, and the business processing is executed on the CPU, enabling impeding of business processing to be prevented.

Third Advantageous Effect

The logging processing uses free pages when executing the business processing only when there are free pages present, enabling impeding of business processing to be prevented.

Fourth Advantageous Effect

In the logging processing, the flag 82 of the page structure entity 71 managing the page of the empty region 72 of the destination to which the command execution data (investigation material) has been evacuated is changed so as to indicate becoming a crash dump extraction target. Whether or not the pages of the empty region 72 are a memory dump extraction target may be determined by examining the content of the flag 82, enabling the command execution data to be saved in the storage region 18B of the secondary storage device 18 (see FIG. 2). Enabling, as a result, the command execution data to be extracted with certainty.

Fifth Advantageous Effect

The header data is associated with and appended to the command execution data (investigation material). This thereby facilitates searching a crash dump for the desired investigation material. Data is also included as the region attribute in the header data to indicate which processing the command execution data is for. This thereby enables identification of what sort of content the command execution data is to be achieve during analysis of extracted command execution data.

Sixth Advantageous Effect

When a computation result, or an intermediate computation result, generated by execution of a command is used as command execution data, it can be established whether the command has been executed correctly.

Seventh Advantageous Effect

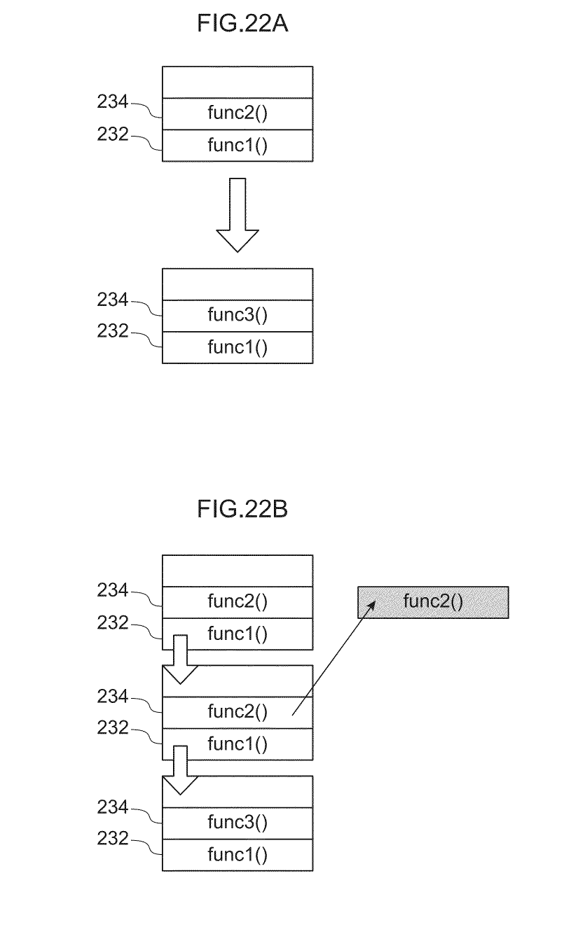

When a thread (command identification data) is used as command execution data, it can be established which commands were executed, and which commands were not executed. In a conventional method, when a thread of a command is used as command execution data the thread is sometimes overwritten. Explanation follows regarding an example of content in which, as illustrated in FIG. 22A, a first command jumps to a second command, and the second command jumps to a third command. As illustrated at the top of FIG. 22A, a thread (fund) that is identification data of the first command is saved in the free page 232 when the first command is executed, and a thread (func2) that is identification data of the second command is saved in the free page 234 when the second command is executed. When returning to the second command from the third command, the thread of the second command (func2) is overwritten by the thread of the third command (func3), as illustrated at the bottom of in FIG. 22A. However, in the present embodiment, as illustrated in the middle of FIG. 22B, when returning to the second command from the third command, prior to overwriting thread of the second command (func2) with the thread of the third command (func3), the thread of the second command (func2) is evacuated. This thereby enables the thread to be saved.

Explanation follows regarding modified examples of the present exemplary embodiment.

First Modified Example As illustrated in FIG. 19D, instead of the OS 18A using the pages from the pages of page 72M onwards according to the sequence 302, the pages may be used from end free page 72E in the reverse sequence (304) to that of the above sequences 300, 301, as illustrated in FIG. 19E. This enables the command execution data to be overwritten in sequence from the oldest. This is done to save the nearest command execution data time-wise to the time of the crash dump time.

Second Modified Example

As illustrated in FIG. 19C, the following configuration may be adopted instead of writing the command execution data from the end free page 72E. Namely, the OS 18A may divide up all the free pages of the empty region 72 into a ⅘ portion from the start free page 72S, and a ⅕ portion from the end free page 72E. The command execution data may then be used in the sequence (401) in the same direction to that of the above sequences 300, 301, from the free page 72E toward the end free page 72E. In this manner, overwriting of the command execution data in sequence from the oldest is enabled. The ⅕ portion is a portion of free pages in which it is expected that data has not been written by the OS 18A. Note that ⅕ is merely an example, and may be determined based on statistical values of the number of free pages that are not written with data by the OS 18A.

Third Modified Example

After the command execution data has first been stored in the storage region 68A2 (FIG. 3, FIG. 13), the following may be performed instead of storing (evacuating) the free pages of the empty region 72. Namely, configuration may be made such that each time the OS 18A generates command execution data, the generated command execution data is directly stored in the free pages of the empty region 72. Doing so eliminates the storage region 68A2, and enables the empty region 72 to be increased. Note that the type of command execution data is not limited to the first to third types described above in cases of evacuation to the empty region 72 after first being stored in the storage region 68A2, or in cases of directly storing in the empty region 72. At least one type of the first to third types may be employed.

Fourth Modified Example

The processing section 91 may execute the following processing between step 216 and step 214. Namely, although the above command execution data was stored in the storage region 68A2 for evacuation detected at step 208 and then evacuated, processing is performed to determine whether or not the command execution data stored in the next page structure entity is the same as the page structure entity acquired at step 204. This is performed so that the command execution data of the same content is not re-evacuated. Note that determination as to whether or not the command execution data has the same content may be made by determining whether or not the magic number data and the sequence number of the header corresponding to each of the command execution data are the same as each other.

Fifth Modified Example

The dumping section 98 may perform the following when one of the CPUs has run out of control (when panic has occurred), instead of storing (dumping) the command execution data in the storage region 18B of the secondary storage device 18 (see FIG. 2B). First, when the CPU is operating correctly, namely when panic is not occurring, the command execution data may be stored in the storage region 18B of the secondary storage device 18 at each evacuation to the empty region 72. Second, the command execution data may be generated, and the command execution data stored in the storage region 18B of the secondary storage device 18 at each direct storing in the empty region 72.

An aspect of technology disclosed herein has the advantageous effect of enabling more command execution data to be saved.

All publications, patent applications and technical standards mentioned in the present specification are incorporated by reference in the present specification to the same extent as if the individual publication, patent application, or technical standard was specifically and individually indicated to be incorporated by reference.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data writing device comprising:
a processor;
a storage section including a plurality of storage regions that store written data; and
a memory storing instructions, which when executed by the processor perform a procedure, the procedure including:
performing first writing that writes data to a storage region of the storage section; and
performing second writing that writes command execution data representing an execution state of each command of a program including a plurality of commands to an expected storage region, among the plurality of storage regions of the storage section, where it is expected that the first writing has not been performed.

2. The data writing device of claim 1, wherein:
in the first writing, data is written to the plurality of storage regions of the storage section in a predetermined sequence; and
in the second writing, the command execution data representing the execution state of each of the commands are written to the plurality of storage regions of the storage section in a reverse sequence to the first writing sequence, and writing is started from a storage region furthest away from a storage region first written to by the first writing.

3. The data writing device of claim 1, wherein:
the storage section includes a predetermined number of specific storage regions;
for each execution of each of the commands, if writing the command execution data to the specific storage regions is performed and the command execution data has already been written to all of the specific storage regions, a third writing is performed that writes different command execution data to the storage region stored with the command execution data; and
in the second writing, the command execution data stored in the storage region is written to the expected storage region prior to writing the different command execution data to the storage region stored with the command execution data.

4. The data writing device of claim 1, wherein:
a second writing section that performs the second writing is capable of executing a command of a program, and the second writing is stopped if the second writing section executes the command.

5. The data writing device of claim 1, wherein:
in the second writing, the second writing is stopped if the data, or the command execution data, has been written to all of the plurality of storage regions of the storage section.

6. The data writing device of claim 1, wherein:
the command execution data is at least one selected from the group consisting of first data generated when the command has been executed, second data used to execute the command, and third data that identifies the executed command.

7. The data writing device of claim 1, wherein:
the command execution data is set to be written; and
in the second writing, the command execution data is written if the command execution data has been set to be written.

8. The data writing device of claim 1, wherein:
the second writing is stopped if the second writing has been set to be stopped.

9. The data writing device of claim 1, wherein:
second writing is performed corresponding to each of a respective plurality of programs.

10. The data writing device of claim 1, wherein:
in the second writing, the command execution data and data that identifies the command are associated with each other and written.

11. A computer-readable recording medium having stored therein a program for causing a computer to execute a data writing process, the process comprising:
performing first writing that writes data to a storage region of a storage section including a plurality of storage regions that store written data; and
performing second writing that writes command execution data representing an execution state of each command of a program including a plurality of commands to an expected storage region, among the plurality of storage regions of the storage section, where it is expected that writing of the first writing has not been performed.

12. The data writing program of claim 11, wherein:
in the first writing, data is written to the plurality of storage regions of the storage section in a predetermined sequence; and
in the second writing, the command execution data representing the execution state of each of the commands are written to the plurality of storage regions of the storage section in a reverse sequence to the first writing sequence, and writing is started from a storage region furthest away from a storage region first written to by the first writing.

13. The data writing program of claim 11, wherein:
the storage section includes a predetermined number of specific storage regions;
for each execution of each of the commands, if writing the command execution data to the specific storage regions is performed and the command execution data has already been written to all of the specific storage regions, processing including a third writing that writes different command execution data to the storage region stored with the command execution data is further executed on the computer; and
in the second writing, the command execution data stored in the storage region is written to the expected storage region prior to writing the different command execution data to the storage region stored with the command execution data.

14. The data writing program of claim 11, wherein:
a second writing section that performs the second writing is capable of executing a command of a program; and
processing including stopping writing the command execution data is further executed on the computer if the second writing section executes the command.

15. The data writing program of claim 11, wherein:
processing including stopping the second writing is further executed on the computer if the data, or the command execution data, has been written to all of the plurality of storage regions of the storage section.

16. A data writing method comprising:
performing first writing that writes data to a storage region of a storage section including a plurality of storage regions that store written data; and
by a processor, performing second writing that writes command execution data representing an execution state of each command of a program including a plurality of commands to an expected storage region, among the plurality of storage regions of the storage section, where it is expected that writing of the first writing has not been performed.

17. The data writing method of claim 16 wherein:
in the first writing, data is written to the plurality of storage regions of the storage section in a predetermined sequence; and
in the second writing, the command execution data representing the execution state of each of the commands are written to the plurality of storage regions of the storage section in a reverse sequence to the first writing sequence, and writing is started from a storage region furthest away from a storage region first written to by the first writing.

18. The data writing method of claim 16, wherein:
the storage section includes a predetermined number of specific storage regions;
for each execution of each of the commands, if writing the command execution data to the specific storage regions is performed and the command execution data has already been written to all of the specific storage regions, processing including a third writing that writes different command execution data to the storage region stored with the command execution data is further executed by the processor; and
in the second writing, the command execution data stored in the storage region is written to the expected storage region prior to writing the different command execution data to the storage region stored with the command execution data.

19. The data writing method of claim 16, wherein:
a second writing section that performs the second writing is capable of executing a command of a program; and
processing including stopping writing the command execution data is further executed by the processor if the second writing section executes the command.

20. The data writing method of claim 16, wherein:
processing including stopping the second writing is further executed by the processor if the data, or the command execution data, has been written to all of the plurality of storage regions of the storage section.
